(19) United States
(12) Patent Application Publication
(10) Pub. No.: US 2007/0036086 A1
(43) Pub. Date: Feb. 15, 2007

(54) System and method of providing communications based on a predetermined device status

(75) Inventors: Edward Walter, Boerne, TX (US); Robert Popp, New Braunfels, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/200,248

(22) Filed: Aug. 9, 2005

(51) Int. Cl. H04J 1/16

(52) U.S. Cl. 370/252

(57) ABSTRACT

A system and method are disclosed for a presence and availability management configuration. The system and method can include a system that pings multiple communication devices associated with a targeted party prior to sending a communication. The system can transmit a target device identifier with a status request (a ping) over a communication network. A response to the ping can provide presence information related to the targeted party. In addition, the system can ping a second target communication device by transmitting a second device identifier over the communication network. In response to a reply from the second target device, additional presence information can be determined. Utilizing a response or responses from the first and second party device(s), (and possibly other devices and/or multiple presence servers), a target device address and a communication mode can be determined, (i.e. where and how to send a communication and to which device).

### FIELD OF DISCLOSURE

The present disclosure relates generally to communication systems and more particularly to sending a communication in response to a predetermined status of at least one communication device.

### BACKGROUND

The phrase “presence and availability management” is often utilized to describe systems that can determine an availability of a party and contact a target party or a subscriber based on a set of rules. A typical presence and availability management system also allows target parties to control their ability to be contacted as they move from place to place by forwarding calls. Presence and availability management systems generally have two primary functions and two secondary functions. One primary function is to collect information from multiple sources regarding a target party's presence and another is to make contact with a target party according to user-defined preferences. Two secondary functions of a typical presence management system include storing user contact information and configuring access control settings for a target party. Presence management systems often do not accurately determine party presence and availability information in real-time. Accordingly, there is a need for an improved presence management system.

### BRIEF DISCRIPTION OF DRAWINGS

Embodiments incorporating teachings of the present disclosure are shown and described with respect to the drawings presented herein, in which:

FIG.1 presents a block diagram of a presence management and availability system;

FIG. 2 presents a simplified flow chart to illustrate a presence management method; and

FIG. 3 is a general diagram representative of an embodiment of a general computer system.

### DETAILED DISCRIPTION OF DRAWINGS

A system and method are disclosed for a presence and availability management configuration. The system and method can include a system that pings multiple communication devices associated with a targeted party prior to setting up a communication with a target party. The system can transmit a target device identifier with a status request (a ping) over a communication network. A response to the ping can provide presence information related to the targeted party and information regarding communication devices associated with the target party. In addition, the system can ping a second target communication device by transmitting a second device identifier over the communication network. In response to a reply from the second target device, additional presence information can be determined. Utilizing a response or responses from the first and second party device(s), and possibly other devices and/or multiple presence servers, a target device address and a communication mode can be determined, (i.e. where and how to send a communication and to which device).

The presence management servers can periodically ping target devices utilizing addresses from a list of addresses and retrieve stored information from the devices and provide presence information to the system. Target party devices may be individually addressed utilizing a telephone number, an IP address, a MAC address, a private IP address, an e-mail address, or a user name.

In one embodiment a presence management server may periodically ping target communication devices and store reply communications. The target communication devices can have presence detectors that determine if a target party is proximate to the target device and can send an IP based presence information to the presence management server. Thus, the presence management server can respond to an originating device, and provide presence data for one or more target devices of a targeted party to the requesting device.

In an alternate configuration, a device such as a presence management server can periodically ping the target devices, store the results of recent pings and provide such results to requesting devices such as a caller's telephone or a telephone system switching device. Thus, a presence management server can actively partake in presence management by periodically pinging the first and second target devices.

In a particular embodiment the presence management server can also ping the target communication devices for status information in response to a caller request. The presence management server can also passively monitor traffic over a communications network and ping devices based on information acquired from the monitoring process. For example, if a first target device is identified as having recent communication activity, or an off hook status, then a determination can be made such as pinging a “last activated device” from a list of target devices associated with a target party.

In another embodiment a presence management server can passively monitor Internet protocol type signals such as session-initiated protocol (SIP) signals to determine the status of a target device. Internet protocol type signals can include a protocol initiation signal, a call set up signal, a call in process signal, a call tear down signal, and an off hook signal.

In one configuration, when the acquired presence information indicates that a first target device cannot accept real-time voice transmissions, an alternate communication mode such as a text message can be auto-configured, or automatically transmitted by the system. In another configuration the caller can be provided with alternate communication modes. One such alternate mode can be transmitting a displayable text message utilizing an instant messaging format or a graphic to the target device. The alternate transmission can be provided to the target party device concurrently with a separate ongoing conversation. In this embodiment the graphic or text message could be displayed on a liquid crystal display of the target device. The message or graphic could provide a simple text message, such as a message to call the originator after the target party completes the current call.

In another configuration, when the acquired presence information related to the second target device indicates that the second target device is in use, a communication could then be sent to the display of the first target device or to a third target device such as a personal computer. Accordingly, alternate selectable communication formats can be provided to an originator or a format can be auto selected by an originating device and utilized to contact the target party.

The communication devices can be Internet protocol (IP) based communication devices, such as an IP based phones, radiotelephones such as a cellular telephone, personal digital assistants or other devices such as those having Internet connection capabilities. The communications may conform to a “chat” application, an instant messaging application and a session initiated protocol (SIP) format.

In another embodiment, the system and method can predict party presence and availability utilizing party presence information obtained from active and passive means (pinging vs. listening). Based on this prediction, a communication mode (text, voice, graphic, page, etc.) and a communication address can be determined and a selected type of communication can be transmitted that has an improved probability of successfully contacting a target party. Thus, when an originator desires to communicate with a target party, the originator can be provided with sending options including a type or location of a receiving device and a mode (i.e. a format) based on a combination of passively monitored presence information and actively acquired presence information of the target device or target party.

In yet another embodiment it can be determined if a target phone will enter into a communication session based on a request from a sender. The sender can be provided with at least one alternate communication option when the target device will not initiate the communication session. The sender's device may automatically determine an address and a format for the alternate communication option based on a list of contact devices associated with the target party.

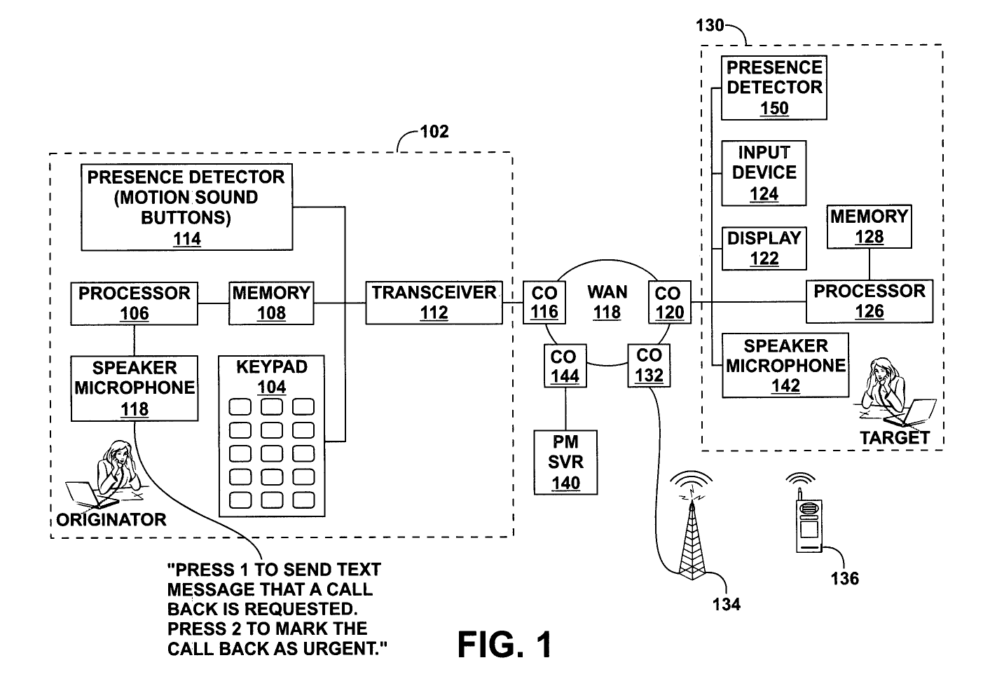

Referring to FIG. 1, an exemplary presence and availability management system is illustrated. The disclosed system utilizes an Internet protocol (IP) topology; however, other topologies could also be utilized. A first IP phone 102 can include a keypad 104, a processor 106, a memory 108, a speaker/microphone 118, a transceiver 112, and a presence detector 114. The first IP based phone 102 can be connected to a wide area network (WAN) 118 via a central office 116. Presence detector 114 can take many forms such as a monitor that monitors the off hook switch or any input to the keypad 104. The presence detector may be a voice-activated switch or a motion switch that monitors sound or movement proximate to the first IP phone 112. The presence detector can also monitor, store and time stamp secession initiated protocol signals that are transmitted or received by transceiver 112. Thus, the presence detector 114 can determine if activity has occurred proximate to the first IP phone 112 and such detected activity can be stored in the memory 108. Radiotelephone 136 can also have a memory and a presence detector (not shown) and log presence information similar to the fist and second IP phones 102 and 130.

A second IP phone 130 can be coupled to the WAN 118 via a second central office 120. The second IP phone 130 can have the same or similar components and functions as the first IP phone 102. The second IP phone 130 can have a second display 122, a second processor 126, a second memory 128, a second speaker/microphone 142, and a second input device 124 (e.g. a keypad). As explained above, the second memory 128 of second IP phone 130 can also store presence information regarding the target party's activities and activities of the second IP phone 130.

The WAN 118 can also be coupled to a radiotelephone 136, such as a cellular telephone via a wireless network, including elements such as a central office 132 and an antenna 134. A presence management server (PMS) 140 may also be connected to the WAN 118 via a central office 144. In the illustrated configuration, the first IP phone 102 can be considered a callers phone, an originator, or sender of communications and the second IP phone 130 and the radiotelephone 136 can be considered as a receiving or target communication device. Thus, a targeted party may utilize the second IP phone 130 and/or the radiotelephone 136.

In operation, a first party (an originator or sender) utilizing the first IP phone 102 can place a call intended for a second party (a targeted party) who is often present at the second IP phone 130 and also carries the radiotelephone 136. In one implementation, prior to sending a request to initiate communication with the targeted party via the second IP phone 130 or the radiotelephone 136, the first IP phone 102 or the PMS 140 can ping the second IP phone 130 and the radiotelephone 136 utilizing an IP address or a telephone number. Any recent activity of the target party or the target party's devices can be retrieved from memory 128 and transmitted back to the caller responsive to a ping.

The word “ping” has its origin from the term “Packet Internet Groper” and the word ping as it is utilized herein, should not be strictly construed but should be given a broader definition such as a request for information. A ping command can be utilized to test the status, historical usage and availability of target device on a network. Thus, the first IP phone 102 or the PMS 140 can send a ping command including a phone number, an IP address or the domain name over the communication network 118 to target devices. Each target devices will typically have a device identifier or device address and each of the target devices can be pinged utilizing the device identifiers. Target devices may be individually addressed utilizing device identifiers such as a telephone number, an IP address, a MAC address, a private IP address, or a user name.

In a particular embodiment the PMS 140 can periodically ping the target devices to receive an up-to-date status or activity information and make this presence information available to the originating telephone upon a ping request from the originating phone. In other embodiments communications from target devices can be monitored over the communication network 118 by the PMS 140. This monitoring can include identifying target devices having recent communication activity. Responsive to this monitored activity, target devices having a most recent communication activity can be targeted for communication or a ping. Thus, communications can be selectively sent to one of the first and the second target devices based on the acquired presence information. In one configuration the sender of the communication can be provided with presence information and/or a list of target devices and the sender can select what communication device, communication method or communication mode the sender would like to utilize to initiate communications.

In one embodiment, a ping communication is sent to at least one PMS 140 (possibly located at a central office). The PMS 140 may periodically engage in communication with the second IP phone 130 or may monitor communication activity of the second IP phone 1.30. The ping may also be sent directly to the second IP phone 130 to acquire presence and availability information. If the first IP phone 102 gets a reply that the second IP phone 130 is available for communication, then a set up communication can be sent by the first IP phone 102 to the second IP phone 130. If the reply to the ping is not successful, then the second IP phone 130 may be busy or in use, and the first IP phone 102 may ping alternate target destinations such as the PMS 140 or the radiotelephone 136. Alternately, the first IP phone 102 may send alternate communications such as a communication in text message communication mode where a text message is sent to the second IP phone 130.

In one configuration, the second IP phone 130 and radiotelephone 136 may store usage history such as recent usage or historical time of day usage and may respond to a ping command by sending a reply indicating that the user of the second IP phone 102 (i.e. the targeted party) has just hung up (and is available) or that there is a high probability that at a particular time of day that the targeted party is proximate to the phone and able to answer the call. Responsive to this acquired information, the first IP phone, or an intermediary call routing device, may route a call to the second IP phone 130. The second IP phone 130 may also provide a low probability of availability indicator, wherein the call would be routed to another target device.

In another configuration, the PMS 140 can receive a ping request from the first IP phone 102 prior to an attempt by the first IP phone 102 to make contact with a target device. The PMS 140 can provide stored status information regarding the status of target devices. The PMS 140 may acquire the status information based on historical, but recent activity of the second IP phone 130, the radiotelephone 132 and other target devices, such as a computer running an application having communication capabilities (not shown). Alternately, the PMS 140 can periodically ping the second IP phone 130 for updated status information or may ping the second IP phone 130 based on the request from the first IP phone 102. Pinging IP phones is considered an active mode of acquiring status information, wherein monitoring transmissions from an IP phone or a radiotelephone would be considered a passive mode of acquiring presence information.

A probability can be assigned to specific target devices responsive to acquired information so that sending a communication to the specific target device will result in a higher probability that the communication will successfully reach the targeted party. All of the target devices (i.e. the first target device, the second target device and a third target device (not shown)) can be assigned a probability based on the presence information and other information (historical availability based on time of day etc.) and based on the determined probability, the call can be selectively routed to a target device (highest probability first, the second highest probability second and so on).

In another embodiment when the second IP phone 130 is in use, such as during a call with another party, the first IP phone 102 can send a text message to the second phone 130 requesting an estimated “time of availability.” The targeted party could push one (1) on the keypad to indicate that the target party will be finished in one minute. When the first IP phone 102 receives the estimated hold time, the calling party can receive a text or voice message, such as, “The party has estimated that they will be busy for one more minute, if you would like to send a text message press one (1) now, if the message is urgent press two.”

In response to the target device user input, the first IP phone 102 could send an IP based text message to the second IP phone 130, and the second IP phone 130 could display the text message on the second display 122 while the second IP phone 130 is in use, (e.g. while the targeted party is talking on the phone). In alternate embodiments, if the second phone IP 130 is set to “do not disturb”, the text message could also be sent to the second display 122 on the second IP phone 130.

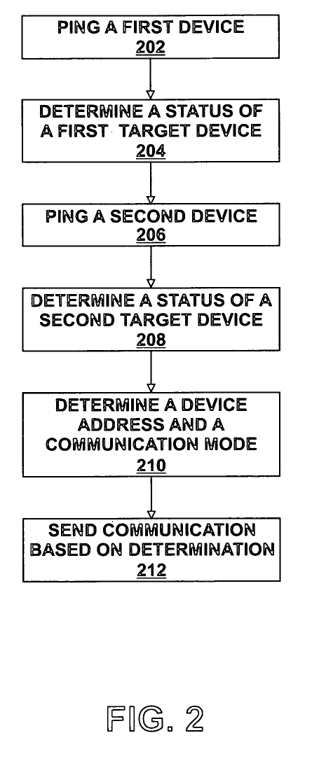

Referring to FIG. 2, a method for acquiring presence and availability data and sending a communication responsive to the acquired data is provided. At step 202, a first target communication device is queried or pinged for status information. The first target communication device can be an end user device but may be a presence management server. At step 204, a status, including presence availability information of the first targeted device is acquired or determined. On such status may be historical activity and another status may be whether a communication device will enter into a communication session.

At step 206, a second target device of the targeted party is pinged. The second target device could be a second target telephone device or at a presence management server at another central office. A status of the second target communication device including presence and availability information is determined at step 208. The status may be a busy signal, a do not disturb signal, an out of office reply or an indication or a probability that the targeted party is proximate to the target device and is available for communication.

The status information can be determined utilizing passive or active methods and may be determined by an originating device receiving information directly from the target device. Generally, IP communication formats define a set of messaging signals, such as off hook, call initiation, hang up, call waiting and call tear down. Any of these control commands may be utilized to determine status or transmit status information. At step 210, a targeted party device is determined and accordingly a device address can be determined and a mode for communication can be determined based on the acquired status information and the device information.

The target party device can be determined in many ways. In one embodiment, the target party device can be determined by a default setting, possibly a user selected default selection. In another embodiment the system can auto-select a target party device based on a call list having probabilities assigned to each device address in the list wherein a highest probability device address is selected for contacting the target party. In a particular embodiment the caller can be provided with different selections for contacting the target party and presented with presence information and a corresponding call list. A communication can be sent according to the selected address and mode of communication at block 212.

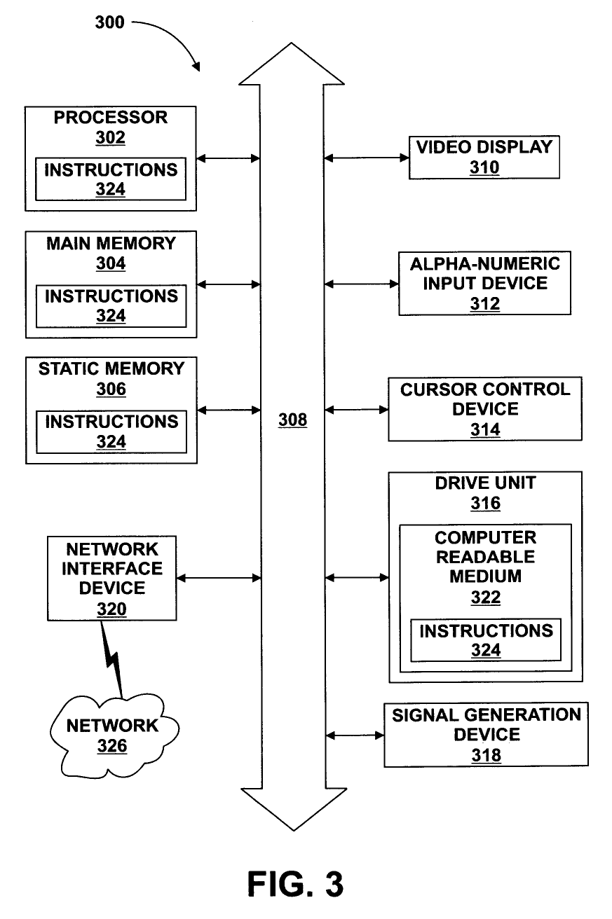

Referring to FIG. 3, an illustrative embodiment of a general computer system is shown and is designated 300. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics-processing unit (GPU), or both. Moreover, the computer system 300 can include a main memory 304 and a static memory 306 that can communicate with each other via a bus 308. As shown, the computer system 300 may further include a video display unit 310, such as a liquid crystal display (LCD), an organic light emitting diode (OLED), a flat panel display, a solid-state display, or a cathode ray tube (CRT). Additionally, the computer system 300 may include an input device 312, such as a keyboard, and a cursor control device 314, such as a mouse. The computer system 300 can also include a disk drive unit 316, a signal generation device 318, such as a speaker or remote control, and a network interface device 320.

In a particular embodiment, as depicted in FIG. 3, the disk drive unit 316 may include a computer-readable medium 322 in which one or more sets of instructions 324, e.g. software, can be embedded. Further, the instructions 324 may embody one or more of the methods or logic as described herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 324 or receives and executes instructions 324 responsive to a propagated signal, so that a device connected to a network 326 can communicate voice, video or data over the network 326. Further, the instructions 324 may be transmitted or received over the network 326 via the network interface device 320.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A presence management method comprising:
pinging a first target device of a targeted party by transmitting a first device identifier over a communication network;
determining presence information related to the first target device based on a response to the pinging of the first target device;
pinging a second target device of the targeted party by transmitting a second device identifier over the communication network;
determining presence information related to the second target device based on a response to the pinging of the second target device; and
selecting a party device address of one of the first and the second target devices and a selected communication mode to send a communication based on the determined presence information related to the first target device and the second target device.

2. The method of claim 1, further comprising sending the communication to the second target device when the acquired presence information related to one of the first and second target device indicates that one of the first target device is in use and the second device is available.

3. The method of claim 1, further comprising sending a text communication to the first target device when the first target device is providing a voice communication.

4. The method of claim 1, wherein the first target device is an Internet protocol (IP) phone, the presence information indicates the first target device is busy with a call, and wherein the communication is a text message transmitted while the first target device is in use, using an instant messaging protocol to provide the text message to a display on the IP phone.

5. The method of claim 1, wherein the presence information is determined utilizing a passive method and an active method, wherein the active method requests and receives data from the memory of a targeted device.

6. The method of claim 1, wherein a presence management server is pinged and the presence management server pings the first and second target devices on a periodic basis and provides a presence status to a requesting device.

7. The method of claim 1, further comprising:
monitoring Internet protocol communications from target devices over the communication network;
identifying target devices, including the first and second target devices, having recent communication activity; and
pinging the first and second target devices having a most recent communication activity.

8. The method of claim 1, further comprising selectively sending a communication to one of the first and the second target devices based on the acquired presence information.

9. The method of claim 8, wherein the communication is sent via an Internet protocol (IP) based signaling protocol.

10. The method of claim 1, further comprising separating a text transmission for a voice transmission at the first target device.

11. The method of claim 1, wherein the first party device is an Internet protocol (IP) compatible telephone configured to receive and display a text message.

12. The method of claim 11, wherein when the text message is received when the first target device is in use.

13. The method of claim 1, further comprising utilizing one of a protocol initiation signal, a call set up signal, a call in process signal, a call tear down signal, an off hook signal, and a computer application initiation signal, to determine the first and second device identifier to ping the first and second target devices.

14. The method of claim 1, further comprising determining a predicted party presence and communication availability utilizing the party presence information related to the first and second party devices.

15. The method of claim 1, further comprising routing a communication to an identified target communication device based on the predicted target presence and communication availability.

16. The method of claim 15, wherein the identified target communication device is the second target device.

17. The method of claim 1, further comprising linking a party device address to one of a telephone number, an IP address, a MAC address, a private IP address, or a user name.

18. A method of communicating comprising:
determining whether an Internet protocol (IP) phone will enter into a voice based communication session based on a request from a sender;
providing the sender with at least one alternate communication option when the IP phone will not initiate the voice based communication session;
determining a format for the alternate communication option; and
transmitting a communication via the alternate communication option to the IP phone.

19. The method of claim 18, further comprising determining whether an Internet protocol IP phone will enter into a voice based communication session by detecting a busy signal.

20. The method of claim 18, wherein determining whether an Internet protocol IP phone will enter into a voice based communication session further comprises determining when the IP phone hand set is off hook.

21. The method of claim 18, wherein determining whether an Internet protocol IP phone will enter into a voice based communication session further comprises determining if a do not disturb feature has been activated.

22. The method of claim 18, wherein the format for the alternate communication option is a text message.

23. The method of claim 18, wherein a second IP phone determines whether the IP phone will enter into the voice based communication session.

24. The method of claim 18, wherein transmitting the communication via the alternate communication option is performed concurrently with the IP phone being in a voiced based communication session with another device.

25. An Internet protocol (IP) based telephone system comprising:
a transceiver configured to communicate voice over IP data utilizing an IP communication format;
a display configured to display caller defined text messages transmitted from a sending device; and
wherein the transceiver is configured to translate the voice over IP data to audio signals; and
a processor coupled to the transceiver and configured to facilitate delivering the caller defined text message to the display.

26. The system of claim 25, wherein the transceiver is configured to receive audio packets and textual packets and the processor is configured to facilitate delivering audio packets to a speaker and textual packets to a display.

27. A computer readable medium tangibly embodying a program of instructions to manipulate a processor to:
ping a first target device of a targeted party by transmitting a first device identifier over a communication network;
determine presence information related to the first target device based on a response to the pinging of the first target device;
ping a second target device of the targeted party by transmitting a second device identifier over the communication network;
determine presence information related to the second target device based on a response to the pinging of the second target device; and
select a party device address of one of the first and second target devices and communication mode to send a communication based on the determined presence information related to the first target device and the second target device.

28. The computer readable medium of claim 27, further manipulating the processor to determine presence information by receiving one of a busy signal, an off hook signal, and a do not disturb status.

29. The computer readable medium of claim 27, further manipulating the computer to format a text message and transmit the text message utilizing an IP address.
